(19) United States
(12) Patent Application Publication
(10) Pub. No.: US 2005/0088300 A1
(43) Pub. Date: Apr. 28, 2005

(54) Device for exchanging environmental information between a master unit and a slave unit

(76) Inventor: Cham Ching Leung, Hong Kong (HK)

Correspondence Address: JACKSON WALKER L.L.P.;Suite 2100, 112 E. Pecan Street, San Antonio, TX, 78205, US

(21) Appl. No.: 10/961,708

(22) Filed: Oct. 8, 2004

(30) Foreign Application Priority Data
Oct. 10, 2003 (CN) 200310111779.6

(51) Int. Cl. G08B 1/08

(52) U.S. Cl. 340/539.26

(57) ABSTRACT

In a device for exchanging data between a master unit and a slave unit the master unit has an energy source, a display for presenting environmental information, and a first transceiver for transmitting energy and receiving data signals. The slave unit has an energy storage device, an sensor for obtaining environmental information, and a second transceiver circuit for receiving energy and transmitting data signals. Energy for operation of the slave unit is transmitted from the master unit to the slave unit and stored in the energy storage device. Environmental information is then transmitted from the slave unit to the master unit and presented on the display.

This application claims priority from Chinese patent application number 200310111779.6 filed on Oct. 10, 2003.

### BACKGROUND OF THE INVENTION

1. Field of the Invention

The invention relates to the remote detection of environmental information such as temperature, humidity and air pressure, and in particular to a device for exchanging environmental information between a master unit and a slave unit.

2. Description of Prior Art

Conventionally, if it is needed to measure environmental information such as the temperature, humidity, and air pressure in a closed area or space, the detection apparatus placed in the closed space is connected to the exterior through a wire or wireless transmission system. If a wire is used the closed area or space must be breached to enable the wire to pass back to the exterior. If a wireless system is used the transmitter in the closed space must have a remote power source such a batteries that need routine maintenance and/or replacement. Again the closed area or space must be breached to enable the maintenance and/or replacement activity. In some situations it is, or might be, desirable or a requirement for the integrity of a closed area or space to be maintained.

### SUMMARY OF THE INVENTION

It is an object of the present invention to provide a device for exchanging environmental information such temperature, humidity and/or air pressure data between a master unit and a slave unit located in a closed area which does not interfere with the sealed integrity of the area.

According to a first aspect of the invention there is provided a device for exchanging temperature, humidity and/or air pressure data between a master unit and a slave unit: the master unit comprising an energy source, a display, a transmitter for transmitting an unmodulated radio signal, and a receiver for receiving temperature, humidity and/or air pressure information for presenting on the display; the slave unit comprising an energy storage device, a sensor for obtaining temperature, humidity and/or air pressure information, a transmitter for transmitting temperature, humidity and/or air pressure information, and a receiver circuit for receiving the unmodulated radio signal and wherein energy from the unmodulated radio signal is stored in the energy storage device and activates the slave unit.

According to a second aspect of the invention there is provided a device for exchanging data between a master unit and a slave unit: the master unit comprising an energy source, a display for presenting environmental information, and a first transceiver for transmitting energy and receiving data signals; the slave unit comprising an energy storage device, an sensor for obtaining environmental information, and a second transceiver circuit for receiving energy and transmitting data signals, and wherein energy for operation of the slave unit is transmitted from the master unit to the slave unit and stored in the energy storage device, and environmental information is transmitted from the slave unit to the master unit and presented on the display.

Preferably, the slave unit has a minimum operating voltage and operates when a voltage of the energy storage device equals or exceeds the minimum operating voltage.

Preferably, the first transceiver has a first coil and the second transceiver has a second coil inductively coupled to the first coil for exchanging energy and data signals between the master and salve units.

Preferably, the master further includes an interface for transmitting the environmental data to a control location, the interface including one of RS485, CAN, M-BUS, INTERNET, LAN and wireless transmission.

Further aspects of the invention will become apparent from the following drawings and description.

### BRIEF DESCRIPTION OF THE DRAWINGS

Embodiments of the invention will now be described with reference to drawings in which:

FIG. 1 illustrates a system for remotely detecting temperature, humidity and/or air pressure according to the present invention;

FIG. 2 is a function block diagram of the system;

FIG. 3 is a circuit diagram of a master apparatus;

FIG. 4 is a circuit diagram of a slave apparatus; and

FIG. 5 is a flow chart showing a method of the invention.

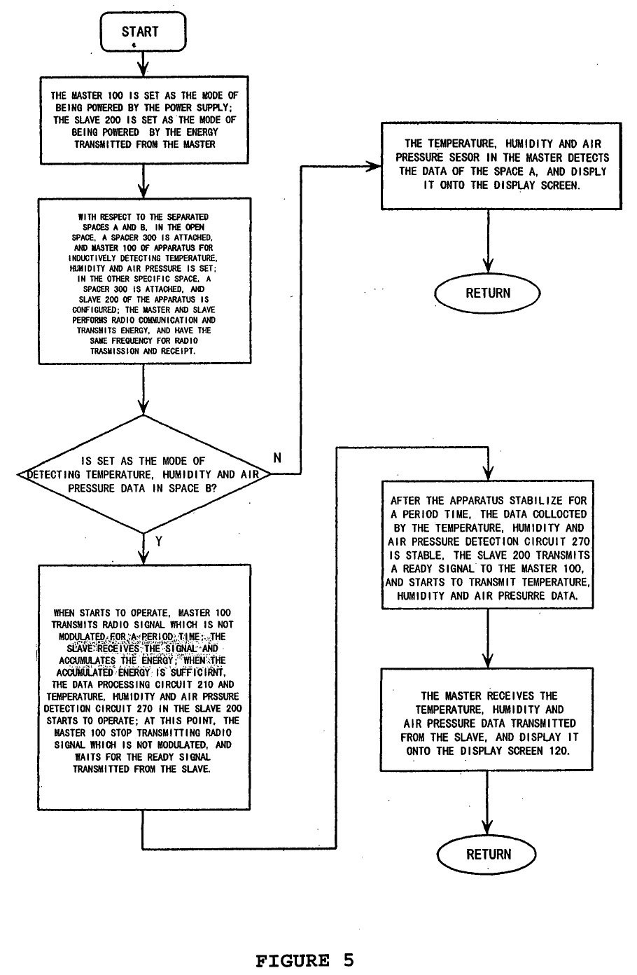

### DESCRIPTION OF THE PREFERRED EMBODIMENTS

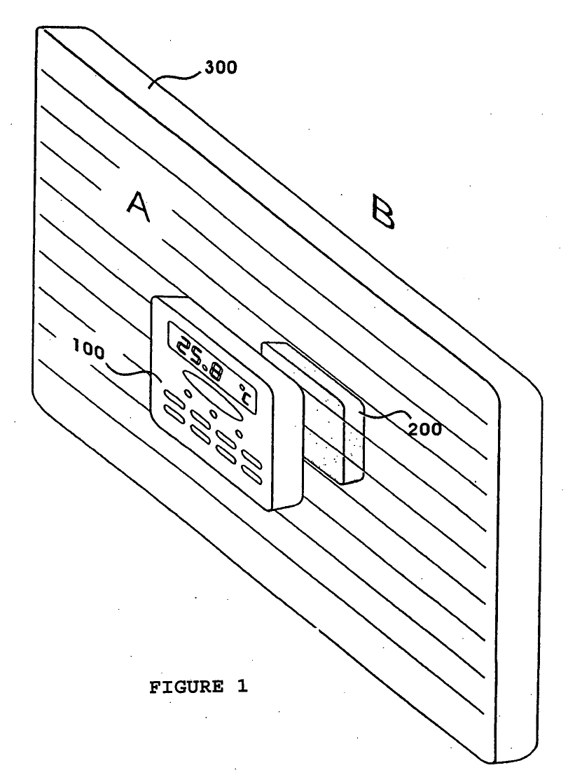

Referring to FIG. 1, a system for remotely detecting temperature, humidity and air pressure through a barrier 300 comprises a master unit 100 located in a first area A on one side of the barrier 300 and a slave unit located in a second area B on a second side of the barrier 300. In the context of the current invention second area B is a closed area.

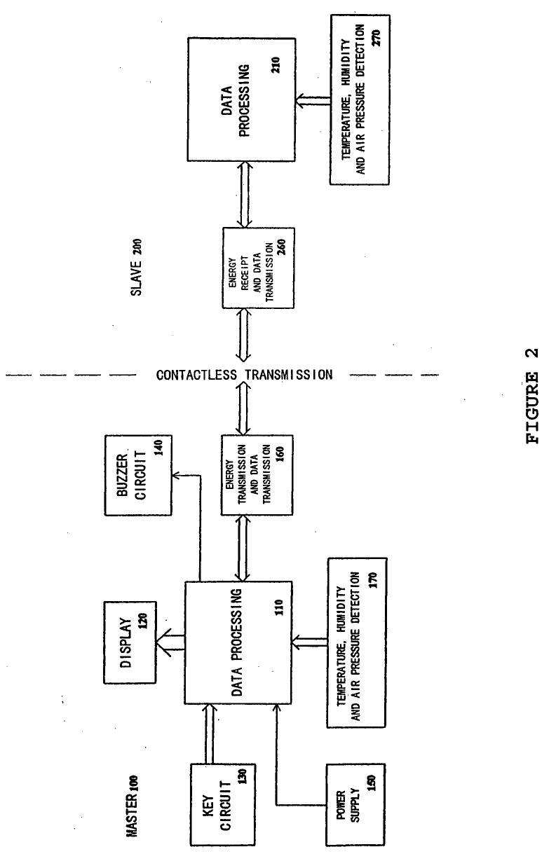

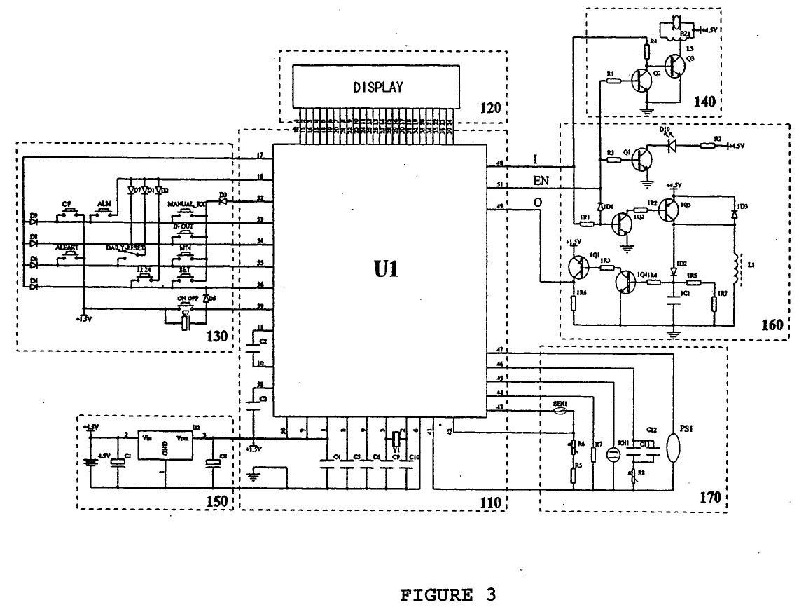

Referring to FIGS. 2 to 4, the master 100 comprises a data processing circuit 110, a power supply 150, a temperature, humidity and air pressure detecting circuit 170, a display 120, and a transceiver circuit 160 for transmitting energy and sending and receiving data signals. The power supply circuit 150 provides power for the master 100 from a known source such as a battery or external energy source through a step down and regulating circuit. The data processing circuit 110 comprises a microprocessor U1 whose input/output (I/O) ports are connected to the temperature, humidity and air pressure detection circuit 170, the display circuit 120 and transceiver circuit 160. The master 100 further comprises a buzzer circuit 140 and an input circuit 130; the input control terminals of the buzzer circuit 140 and the input circuit 130 are connected to the I/O ports of the microprocessor U1 in the data processing circuit 110.

The slave 200 comprises a data processing circuit 210, a temperature, humidity and air pressure detection circuit 270 and second transceiver circuit 260 for receiving energy and sending and receiving data signals. The data processing circuit 210 comprises a microprocessor U3 whose I/O ports are connected to the temperature, humidity and air pressure detection circuit 270 and transceiver circuit 260.

The master 100 is powered by a power supply 150 therein. However, the slave 200 does not have a power supply circuit. Energy is transmitted to the slave 200 from the transceiver circuit 160 of the master 100 by short-range radio transmissions. The transceiver circuit 260 of the slave 200 receives the transmitted electrical energy and stores it in an electrolytic capacitor 2C1 in the energy receipt part of the transceiver circuit 260. The electrolytic capacitor 2C1 provides a power supply for use by the slave 200.

The transceiver circuit 160 of the master 100 has a resonance circuit comprising an inductive coil L1 and a capacitor 1C1. A complementary resonance circuit in the second transceiver circuit 260 of the slave 200 comprises a second inductive coil L2 and a capacitor 2C3. The two resonant circuits have the same resonance frequency.

One end of the inductor L2 is connected to the ground and the other end is connected to the cathode of a diode 2D2. The anode of the diode 2D2 is connected to the positive electrode VCC of the power supply. The electrolytic capacitor 2C1 is connected between the positive electrode VCC of the power supply and the ground.

The microprocessor U3 in the slave 200 is a low-power device. In a preferred embodiment of the invention microprocessor U3 is a Tenx technology TM8705 4-Bit Micro-Controller, which has a typical operating voltage and current of 1.5V and 2 μA respectively.

The power supply of the master 100 is direct current supply of 4.5V, and the power supply circuit 150 contains a voltage-stabilizer of 1.5V. The power supply has two outputs, one is used for the transceiver circuit 160, and another, namely, 1.5V, is used for the data processing circuit 110. If the ON/OFF push button is pressed after the apparatus is powered on, the circuit starts to operate. The data processing circuit 110 is the core of the master 100. At beginning, the data processing circuit 110 initialises the system firmware. After initialisation, the data processing circuit 110 continuously samples and processes the data from the temperature, humidity and air pressure detection circuit 170 then transforms the processed data into display data to display it on display 120.

The transceiver circuit 160, which is controlled by the data processing circuit 110, is used to send electric energy and data signals to the slave 200 to enable the slave 200 to obtain operating energy, then to receive the data from the slave 200 and send it into data processing circuit 110. The buzzer circuit 140 is used for alarming of temperature.

The data processing circuit 110 comprises a microprocessor U1, an oscillation circuit, a power-on and reset circuit, and a capacitor. In the preferred embodiment of the invention microprocessor U1 is a Tenx technology TM8705 4-Bit Micro-Controller. In the following description the pin references given relate those of the TM8705. Details can be found at www.tenx.com.tw.

The oscillation circuit comprising a crystal oscillator Y1 and capacitors C9 and C10 provides clock signal for the microprocessor U1. The power-on and reset circuit is a capacitor C3. When powered, the capacitor C3 sends a positive pulse to RESET pin of the microprocessor U1 to causes the microprocessor U1 to run its control program from the beginning. Capacitors C2, C4, C5 and C6 are used to ensure the microprocessor U1 operates correctly.

The temperature, humidity and air pressure detection circuit 170 comprises a temperature sensor SEN1, a humidity sensor RH1, an air pressure sensor PS1, along with various resistors and capacitors. The temperature sensor SEN1 is a thermal resistor whose resistance value varies according to the temperature. The humidity sensor RH1 is a humidity sensitive capacitor whose capacitance value varies according to the humidity. The microprocessor U1 determines the temperature and humidity by measuring the resistance value of SEN1 and the capacitance value of RH1. Resistors R5 and R6 are used to adjust the error of temperature measurement. Resistor R8 and capacitors C11 and C12 are used to adjust the error of humidity measurement.

The transceiver circuit 160 of the master 100 is used to transmit energy to slave 200 and to receive temperature, humidity and air pressure data from the slave 200. During transmission of energy, a carrier with a predetermined frequency is generated from the pin SEG31 of the microprocessor U1, and modulated through a diode 1D1 by a voltage signal generated from the pin SEG34 to generate a modulated wave. The modulated wave is amplified by transistors 1Q2 and 1Q3 and is transmitted through an inductor L1. To receive data a diode 1D2, resistors 1R5 and 1R7 and a capacitor 1C1 demodulate the received carrier, and output the demodulated low frequency data signal from the negative electrode of diode 1D2. The output data signal is subjected to two-stage amplification by transistors 1Q4 and 1Q1, and is input to the microprocessor U1 through the pin SEG32. The diode 1D3 is used to absorb the self-inductive potential generated when the inductor L1 receives signals into power supply.

The input circuit 130 comprises push button switches and a diode array D1-D9. The pins VDD1, SG35, COM5 and COM6 of the microprocessor U1 are connected to the pine SEG36, SEG37, SEG38 and SEG39 through the push button switches and diodes D1-D9. The microprocessor U1 continuously samples the signals generated from the pins SEG36, SEG37, SEG38 and SEG39 and determines whether a push button is pressed so as to enter into different operating modes. The modes include selection of temperature, humidity and air pressure from the master sensors or slave sensors.

The buzzer circuit 140 comprises a buzzer BZ1, an inductor coil L3, transistors Q2 and Q3, and resistors R1 and R4. The buzzer circuit 140 is controlled by signals from pins SEG31 and SEG34 of the microprocessor U1. Pins SEG31 and SEG34 also control data transmission. When transmitting data the output on pin SEG34 is high, the transistor Q2 turns on and the base of the transistor Q3 is low disabling control of the buzzer. To sound the buzzer the output on pin SEG34 is made low and the transistor Q2 turns off so that transistor Q3 can be controlled from pin SEG31.

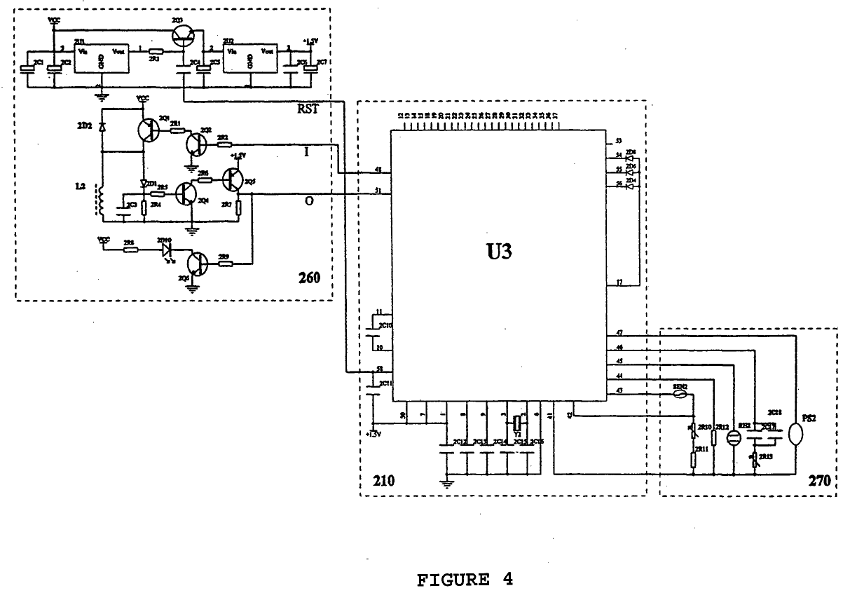

The configuration of the slave 200 is shown in FIG. 4. Inductor L2 in the second transceiver circuit 260 is used receive energy from master 100 and to send temperature, humidity and air pressure data. When inductor L2 receives a signal diode 2D2 extracts energy from the high frequency carrier and stores it into capacitors 2C1 and 2C2. Then the electric energy stored in the capacitors 2C1 and 2C2 is sent into voltage-stabilized chip 2U2 via a voltage buffering circuit comprising 2U1 and 2Q3, to output a 1.5V voltage to be used by the slave 200.

When the voltage across the energy storage capacitors 2C1 and 2C2 changes a signal is sent to pin RESET of the microprocessor U3 to reset it and start operation of the slave 200.

The detection circuit comprising a diode 2D1, a resistor 2R4 and a capacitor 2C3 demodulates the carrier to obtain a control voltage signal, then the control voltage signal is is amplified by 2Q4 and 2Q5 and sent to pin SEG34 of the U3. When the U3 receives the control signal, pin SEG31 outputs temperature, humidity and air pressure data which is amplified by the 2Q2 and 2Q1 and transmitted through inductor L2.

Operation of the system is as follows.

After being turned on and running through an initiation procedure the master 100 determines whether it is set for detecting local or remote temperature, humanity and air pressure. If local mode is set information is obtained from the master temperature, humidity and air pressure detection circuit 170 and shown on display 120.

If remote mode is set the energy transmission and data transmission circuit 160 of the master 100 transmits an unmodulated radio signal for a short period of time. The unmodulated radio signal is received by energy receipt and data transmission circuit 260 of the slave 200 and in used to charge the electrolytic capacitor 2C1. When to the electrolytic capacitor 2C1 has accumulated sufficient energy the slave 200 is reset and begins to operate. The master stops transmitting the unmodulated radio signal.

The temperature, humidity and air pressure detection circuit 270 of the salve 200 is preheated for a period time to enable it to operate stably. The data processing circuit 210 then collects temperature, humidity and air pressure data and stores it into a data storing area. The data processing circuit 210 sends a hand-shake signal to the master 100 to prepare for the transmission of temperature, humidity and air pressure data.

The master 100 waits for the hand-shake signal from the slave 200 When the hand-shake signal is received the master sends a reply signal to the slave 200. If the slave 200 receives the reply signal, it sends the temperature, humidity and air pressure data in the data storing area to the master 100. The master 100 receives the temperature, humidity and air pressure data, and presents it on the display unit 120.

As the slave transmitter is low power the master may also include means for relaying the temperature, humidity and air pressure data to a central control system by remote data transmission means such as RS485, CAN, M-BUS, INTERNET, LAN and wireless transmission.

Where in the foregoing description reference has been made to integers or elements having known equivalents then such are included as if individually set forth herein.

Embodiments of the invention have been described, however it is understood that variations, improvement or modifications can take place without departure from the scope of the appended claims.

1. A device for exchanging temperature, humidity and/or air pressure data between a master unit and a slave unit,
the master unit comprising
an energy source,
a display,
a transmitter for transmitting an unmodulated radio signal, and
a receiver for receiving temperature, humidity and/or air pressure information for presenting on the display,
the slave unit comprising
an energy storage device,
a sensor for obtaining temperature, humidity and/or air pressure information,
a transmitter for transmitting temperature, humidity and/or air pressure information, and
a receiver circuit for receiving the unmodulated radio signal and wherein energy from the unmodulated radio signal is stored in the energy storage device and activates the slave unit.

2. The device of claim 1 wherein the slave unit has a minimum operating voltage and activates when a voltage of the energy storage device equals or exceeds the minimum operating voltage.

3. The device of claim 1 wherein when the slave unit activates it transmits temperature, humidity and/or air pressure information.

4. A device for exchanging data between a master unit and a slave unit,
the master unit comprising
an energy source,
a display for presenting environmental information, and
a first transceiver for transmitting energy and receiving data signals,
the slave unit comprising
an energy storage device,
an sensor for obtaining environmental information, and
a second transceiver circuit for receiving energy and transmitting data signals, and wherein
energy for operation of the slave unit is transmitted from the master unit to the slave unit and stored in the energy storage device, and environmental information is transmitted from the slave unit to the master unit and presented on the display.

5. The device of claim 4 wherein the slave unit has a minimum operating voltage and operates when a voltage of the energy storage device equals or exceeds the minimum operating voltage.

6. The device of claim 4 wherein the first transceiver has a first coil and the second transceiver has a second coil inductively coupled to the first coil for exchanging energy and data signals between the master and salve units.

7. The system of claim 4 wherein the sensor detects one or more of temperature, humidity and air pressure.

8. The system of claim 4 wherein the master further includes an interface for transmitting the environmental data to a control location, the interface including one of RS485, CAN, M-BUS, INTERNET, LAN and wireless transmission.
